(19) United States
(12) Patent Application Publication
(10) Pub. No.: US 2009/0328153 A1
(43) Pub. Date: Dec. 31, 2009

(54) USING EXCLUSION BASED SECURITY RULES FOR ESTABLISHING URI SECURITY

(75) Inventors: Madhu K. Chetuparambil, Raleigh, NC (US); Marc E. Haberkorn, Raleigh, NC (US); Todd E. Kaplinger, Raleigh, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/146,006

(22) Filed: Jun. 25, 2008

(51) Int. Cl. H04L 9/32; G06N 5/02

(52) U.S. Cl. 726/4; 706/48

(57) ABSTRACT

A solution for controlling access to Uniform Resource Identifier (URI) identified resources can receive a request for a resource identified by a URI. The URI associated with the request can be compared against at least one previously established security rule. The security rule can include an exclusion comparison operator and a regular expression defining a pattern. A determination as to whether to grant a requester access to the resource can be based at least in part upon results of the comparing of the URI against the previously established security rule.

### BACKGROUND OF THE INVENTION

The present invention relates to the field of group-based security, more particularly, to using exclusion based security rules for establishing Uniform Resource Identifier (URI) security.

Uniform Resource Identifier (URI) security is a common concern when hosting content over the internet. URI security rules can be established to protect secured content from unwanted access. Typically, the administrator of the server configures URI security rules for each of the protected URIs on the server. Representational State Transfer (REST) is a style of software architecture that strictly refers to a collection of network architecture principles which outline how resources are defined and addressed. The term is commonly used to describe any simple interface which transmits domain-specific data over HTTP without an additional messaging layer such as SOAP or session tracking via HTTP cookies. A RESTful resource can be a resource that is addressed via its URI. Other URI identified content, whether REST based or not, can be also implement URI based security.

In some cases, URI secured resources can greatly outnumber the unsecured resources on a server. It is difficult and time consuming to specify each of the secured resources, as is conventional practice. For example, consider a server that contains thirty resources (which can be a very modest number, depending on the configuration), twenty eight of which need to be secured. Securing the twenty eight resources typically requires a specification of every secure URI associated with a secure resource via logical OR constructs in a relative complex regular expression. It would be simpler, yet not presently possible, to allow specification of an entire URI space, and then to specify a few exceptions (in this case the two unsecured resources) to the standard security rule via an “excludes” clause (e.g., a clause that includes an exclusion comparison operator).

Known solutions implement proxies and security modifications that are able to be configured for inverse white list matching of request URIs for access control based decision matching. These existing solutions, however, lack an ability to prompt a user for security credentials when needed (for secure resources) and upon success to continue the request processing to the originally requested resource.

### BRIEF DESCRIPTION OF THE SEVERAL VIEWS OF THE DRAWINGS

FIG. 1 is a schematic diagram of a system for using exclusion based security rules for establishing Uniform Resource Identifier (URI) based security for URI identifiable resources in accordance with an embodiment of the inventive arrangements disclosed herein.

FIG. 2 is a diagram of a scenario for using exclusion based security rules for establishing URI security in accordance with an embodiment of the inventive arrangements disclosed herein.

FIG. 3 is a flow chart of a method for using exclusion based security rules for establishing URI security in accordance with an embodiment of the inventive arrangements disclosed herein.

### DETAILED DESCRIPTION OF THE INVENTION

The present invention can simplify security configuration of Uniform Resource Identifier (URI) security by allowing the use of exclusion-based security rules in conjunction with the more common inclusion-based security rules. The present invention can allow a user to specify any number of security rules to be used in conjunction with each other, as well as configure other options pertaining to the security rule to secure a URI identifiable resource. Such additional options can include an authentication type, access control (i.e. read, write, execute permissions), a list of acceptable users and/or groups that can access the resource, and the like. The present invention can allow for the remote or local setting of these security rules. Security rules can be implemented using regular expressions that permit exclusion clauses.

That is, the security rules can permit a pattern to be specified where actions are to be taken when a resource does not match the specified pattern (e.g., one defined using a regular expression), which is not presently possible for URI based security engines. Effectively, an inverse white list can be specified, so that when a few unsecured resources relative to a total number of resources exist, patterns to identify the unsecured resources can be specified for URL based security rules using exclusion clauses, where if no exclusion is applicable default programmatic actions are taken (actions needed for secure resources, for example). This eliminates a need to define patterns (using inclusion based regular expressions) for the relatively larger number of secure resources.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

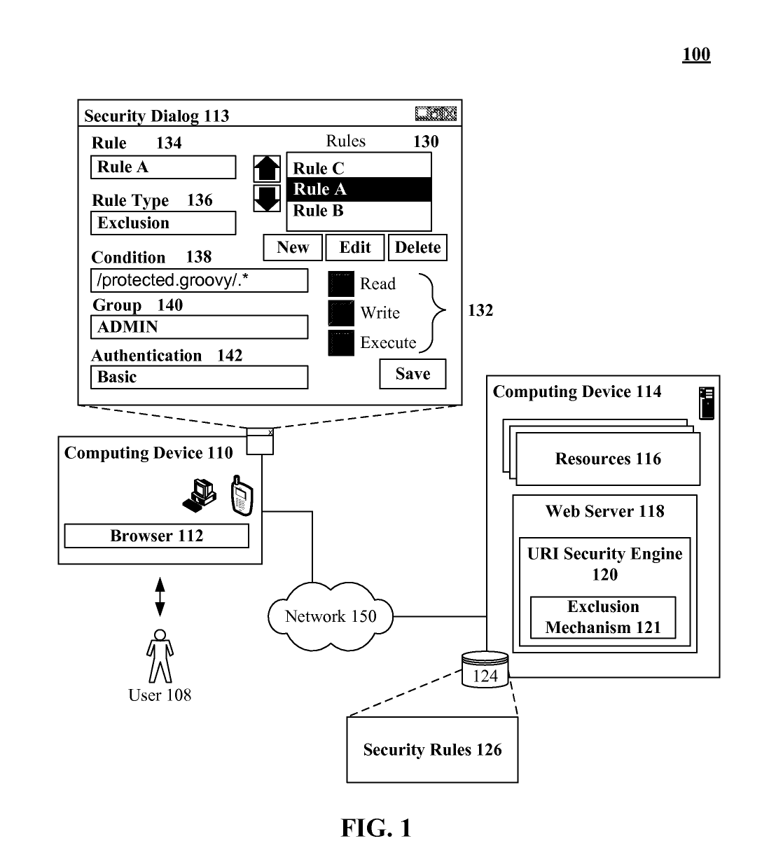

FIG. 1 is a schematic diagram of a system 100 for using exclusion based security rules for establishing Uniform Resource Identifier (URI) based security for URI identifiable resources in accordance with an embodiment of the inventive arrangements disclosed herein. In system 100, computing device 114 can make use of exclusion-based security rules (implemented via exclusion mechanism 121) to protect resources 116. In one embodiment, an optional user interface 113 can be used to define rules for securing the resources 116, where the interface 113 includes an ability to define inclusion and exclusion rules (rule type 136). In another embodiment, security rules can be defined using text-based code. For example, exclusion based (and inclusion based) rules can be defined in a text file that includes regular expressions that permit actions to be taken when a resource does not match a defined pattern. That is, a language for defining security rules that utilizes regular expressions can be enhanced with an exclusion operation, such as a condition triggered when a URI for a resource does not match a defined pattern.

In system 100, computing device 114 can host resources 116 via network 150 using web server 118. User 108 can use a browser 112 of computing device 110 to interact with computing device 114 via network 150. These interactions can permit the user 108 to utilize a resource 116 in accordance with security rules 126 established by the URI security engine 120. The security rules 126 can be stored in a device 114 accessible data store 124. In other words, URI security engine 120 can evaluate each security rule 126 in order of priority to determine the appropriate security settings applicable to requested URIs. The exclusion mechanism 121 can permit exclusion based security rules 126 to be defined and utilized. In one embodiment, exclusion mechanism 121 can be an add-on that enhances a conventional URI security engine 120, where the enhancement allows for the evaluation of exclusion-based security rules 216, which in absence of the add-on would not be a feature of engine 120. In another embodiment, the exclusion mechanism can be an integrated component of the URI security engine 120.

In one embodiment, the user 108 can be an authorized administrator of the Web server 118, who is able to modify the security rules 126 via a security dialog interface 113. As shown, security dialog 113 can include controls 130-142 to allow the customization of the security rules 126. Control 130 can be a listbox in which shows the currently added rules. Controls associated with listbox 130 can allow the user to rearrange the rules (therefore changing their priority), edit, delete, and create new rules. Controls 132 can allow the specification of access controls for the current rule (i.e. read, write, execute permissions). Control 134 can allow the designation of a unique identifier for the current rule. Control 136 can allow the specification of the rule type (i.e. inclusion or exclusion-based rule). Control 138 can allow the specification of the condition to be matched by the rule. Control 138 can specify a string to match in any format (most commonly a regular expression, or regexp). For example, the expression “/protected.groovy/.*” matches any URI that starts with “/protected.groovy/”.

Control 140 can allow for the specification of the users and/or groups in which should be allowed access for the current rule. Control 142 can allow the specification of the authentication method used by the server. Control 142 can allow the use of external authentication modules for more secure authentication (i.e., PAM, LDAP, KERBEROS). It is contemplated that security dialog 113 can be presented in any configuration and is not limited to the configuration shown. The present invention can allow for customization to any arbitrary level and is not limited to the configuration options shown.

As used herein, computing device 114 can be a set of one or more computing devices, which can include server hardware and appropriate software, firmware, and networking elements. Computing device 114 can include resources 116, web server 118, URI security engine 120, exclusion mechanism 121, and data store 124. Computing device 114 can use these devices to allow the use of exclusion-based security settings to simplify the security configuration of resources 116.

Web server 118 can be machine-readable instruction code digitally encoded on a machine usable medium that is configured to enable the listening on a specified port of computing device 114 for incoming Web requests. Web server 118 can receive requests for resources 116 and then provide the resource 116 to the requesting user and device. Resources 116 can be any URI identifiable resource, such as Representational State Transfer (REST) based resource. Resources 116 can include both resources that are to be secured and unsecured. Web server 118 can use URI security engine 120 in conjunction with security rules 126 on data store 124 to secure resources 116.

URI security engine 120 can be machine-readable instruction code digitally encoded on a machine usable medium that is configured to secure the contents of resources 116. URI security engine 120 can include exclusion mechanism 121, which can be machine-readable instruction code digitally encoded on a machine usable medium that is configured to enable the evaluation of exclusion-based security rules to secure resources 116. When an incoming URI request is accepted by web server 118, URI security engine 120 can evaluate each security rule 126, in order of priority, to determine the associated security settings with the requested URI. Once the security settings have been determined, URI security engine 120 can act accordingly to allow or deny access to the requested URI. In some cases, URI security engine 120 can require authentication credentials be provided by the requesting user. In this case, URI security engine 120 can selectively prompt the user for the required authentication credentials. No credentials may be necessary for access to unsecured resources 116. Once provided, URI security engine 120 can determine the associated group or groups and access roles with the user and compare them to the security settings of the requested URI and grant or deny access to a requested secured resource 116 accordingly.

Data store 124 can be physically implemented within any type of hardware including, but not limited to, a magnetic disk, an optical disk, a semiconductor memory, a digitally encoded plastic memory, a holographic memory, or any other recording medium. The data store 124 can be a stand-alone storage unit as well as a storage unit formed from a plurality of physical devices, which may be remotely located from one another. Additionally, information can be stored within each data store in a variety of manners. For example, information can be stored within a database structure or can be stored within one or more files of a file storage system, where each file may or may not be indexed for information searching purposes.

Network 150 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 150 can include local components and data pathways necessary for communications to be exchanged among computing device components and between integrated device components and peripheral devices. The network 150 can also include network equipment, such as routers, data lines, hubs, and intermediary servers which together form a packet-based network, such as the Internet or an intranet. The network 150 can further include circuit-based communication components and mobile communication components, such as telephony switches, modems, cellular communication towers, and the like. The network 150 can include line based and/or wireless communication pathways.

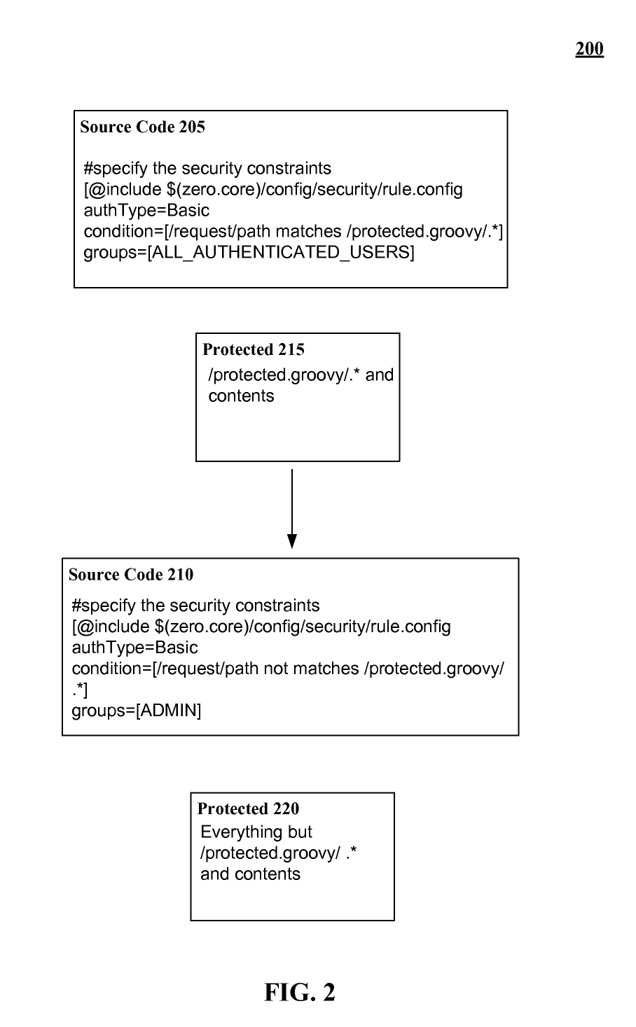

FIG. 2 is a diagram of a scenario for using exclusion based security rules for establishing URI security in accordance with an embodiment of the inventive arrangements disclosed herein. FIG. 2 can illustrate how the present invention can simplify URI security settings by allowing the use of exclusion-based security rules. FIG. 2 can include source code 205, which can illustrate security settings to protect the URIs illustrated in protected 215. FIG. 2 can also include source code 210, which can make use of an exclusion-based security rule to protect the URIs illustrated in protected 220.

Source code 205 can illustrate code used for an inclusion-based security rule, which uses the comparison operator 207 of “matches”In source code 205, the condition is applied when the path matches 207 “/protected.groovy/.*”, therefore protected 215 shows that any URI that starts with protected.groovy and its sub-URIs will be protected.

In source code 210, the condition is applied when the path does not match “/protected.groovy/.*”, therefore protected 220 shows that any URI besides a URI containing “protected.groovy” will be protected. Code 210 uses comparison operator 212 not matches to check for an exclusion to a pattern. One contemplated use of the exclusion comparison operator 212 is to “exclude” unsecure resources from programmatic code that is otherwise executed. This can simplify coding when a large set of URL identifiable resources are secured compared to a set that are unsecured, since only the unsecured ones (as opposed to specifying each secured resource) need to be specified in exclusion based code 210.

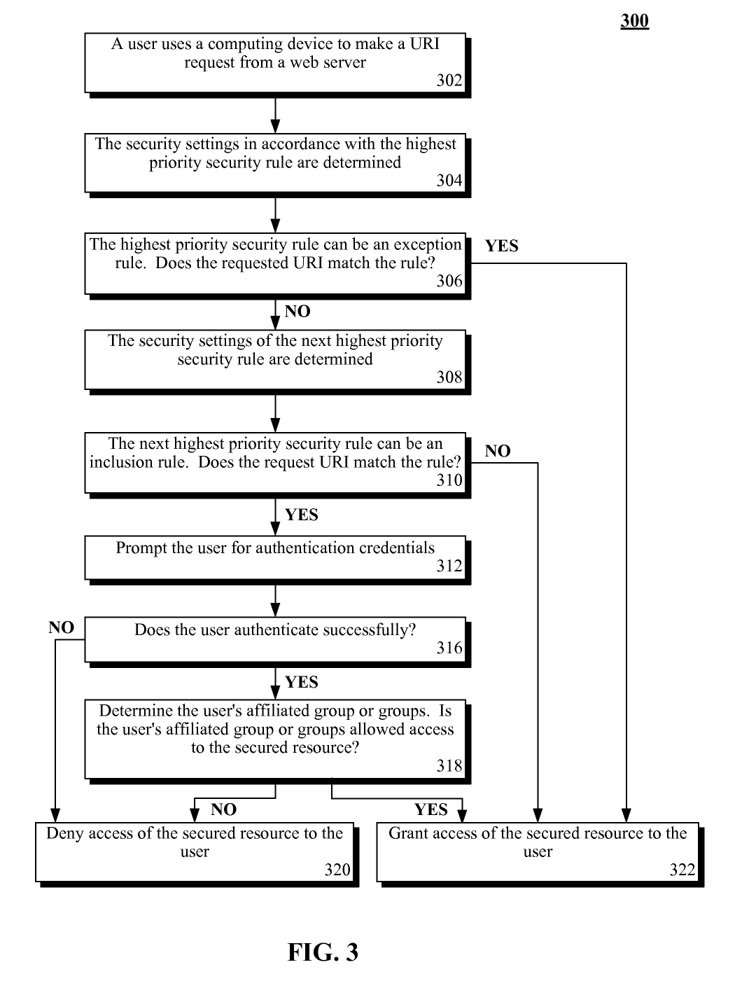

FIG. 3 is a flow chart of a method 300 for using exclusion based security rules for establishing URI security in accordance with an embodiment of the inventive arrangements disclosed herein. Method 300 can illustrate a scenario in which two security rules can be configured, wherein one is an inclusion and the other an exclusion rule. In this scenario, the exclusion rule can have higher priority than the inclusion rule.

Method 300 can begin in step 302, where a user can use a computing device to make a URI request from a web server. In step 304, the security settings in accordance with the highest priority security rule are determined. In step 306, the highest priority rule can be determined to be an exclusion rule and it can be compared to the requested URI. In step 306, if the rule matches the requested URI, method 300 can continue to step 322, where the user can be granted access to the secured resource. If in step 306, the rule doesn't match the requested URI, method 300 can continue to step 308, where the security settings of the next highest priority security rule can be determined. In step 310, the next highest priority security rule can be determined to be an inclusion rule and it can be compared to the requested URI. If in step 310, the requested URI does not match the security rule, method 300 can continue to step 322, where the user can be granted access to the secured resource. If in step 310, the requested URI matches the rule, method 300 can continue to step 312, where the user can be prompted and then supply authentication credentials. In step 316, it can be determined if the user authenticated successfully. If in step 316, the user does not authenticate successfully, method 300 can continue to step 320, where the user can be denied access to the secured resource. If in step 316, the user authenticates successfully, method 300 can continue to step 318, where the user's affiliated group or groups can be determined. Also in step 318, it can be determined if the user's affiliated group or groups should be allowed access to the secured resource. If in step 318, the user should be granted access to the secured resource, method 300 can continue to step 322, where the user can be granted access to the secured resource. If in step 318, the user should not be granted access to the secured resource, method 300 can continue to step 320, where the user can be denied access to the secured resource.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for controlling access to Uniform Resource Identifier (URI) identified resources comprising:
receiving a request for a resource identified by a URI;
comparing the URI associated with the request against at least one previously established security rule, said security rule including an exclusion comparison operator and a regular expression defining a pattern; and
determining whether to grant a requester access to the resource based at least in part upon results of the comparing of the URI against the previously established security rule.

2. The method of claim 1, further comprising:
determining that the URI matches the pattern defined by the regular expression; and
evaluating the security rule as FALSE based upon the exclusion comparison operator.

3. The method of claim 1, further comprising:
determining that the URI does not match the pattern defined by the regular expression; and
evaluating the security rule as TRUE based upon the exclusion comparison operator.

4. The method of claim 1, further comprising:
programmatically determining that the requested resource is a secure resource when the security rule evaluates as FALSE and performing at least one security action before granting access to the resource responsive to the request, wherein the at least one security action prompts a user for additional security credentials and bases access of the requested resource upon whether credentials provided responsive to the prompts are valid; and
programmatically determining that the requested resource is an unsecure resource when the security rule evaluates as TRUE and granting access to the resource responsive to the request.

5. The method of claim 1, wherein said at least one security rule comprises a plurality of security rules, wherein at least two of said plurality of security rules comprise an exclusion comparison operator for evaluating the URI against a pattern defined in the corresponding security rule.

6. The method of claim 5, wherein at least one of the plurality of security rules comprise an inclusion comparison operator for evaluating the URI against an associated pattern defined in the corresponding security rule.

7. The method of claim 6, further comprising:
establishing an evaluation order for the plurality of security rules; and
processing each security rule in order until one of the security rules evaluates as TRUE, in which case lowered ordered security rules are not processed for the request.

8. The method of claim 1, wherein the resource is a RESTful resource.

9. The method of claim 1, wherein an application server is used to perform the receiving, comparing, and determining in accordance with programmatic rules digitally encoded within a machine readable medium that are executed by the application server, wherein the security rules utilized by the application server are based upon a plurality of matching rules comprising pattern matching, exact matching, and extension based matching.

10. A computer program product for controlling access to Uniform Resource Identifier (URI) identified resources comprising:
a computer usable medium having computer usable program code embodied therewith, the computer usable program code comprising:
computer usable program code configured to receive a request for a resource identified by a URI;
computer usable program code configured to compare the URI associated with the request against at least one previously established security rule, said security rule including an exclusion comparison operator and a regular expression defining a pattern; and
computer usable program code configured to determine whether to grant a requester access to the resource based at least in part upon results of the comparing of the URI against the previously established security rule.

11. The computer program product of claim 10, further comprising:
computer usable program code configured to determine that the URI matches the pattern defined by the regular expression; and
computer usable program code configured to evaluate the security rule as FALSE based upon the exclusion comparison operator.

12. The computer program product of claim 10, further comprising:
computer usable program code configured to determine that the URI does not match the pattern defined by the regular expression; and
computer usable program code configured to evaluate the security rule as TRUE based upon the exclusion comparison operator.

13. The computer program product of claim 10, further comprising:
computer usable program code configured to programmatically determine that the requested resource is a secure resource when the security rule evaluates as FALSE and performing at least one security action before granting access to the resource responsive to the request, wherein the at least one security action prompts a user for additional security credentials and bases access of the requested resource upon whether credentials provided responsive to the prompts are valid; and
computer usable program code configured to programmatically determine that the requested resource is an unsecure resource when the security rule evaluates as TRUE and granting access to the resource responsive to the request.

14. The computer program product of claim 10, wherein said at least one security rule comprises a plurality of security rules, wherein at least two of said plurality of security rules comprise an exclusion comparison operator for evaluating the URI against a pattern defined in the corresponding security rule.

15. The method of claim 14, wherein at least one of the plurality of security rules comprise an inclusion comparison operator for evaluating the URI against an associated pattern defined in the corresponding security rule.

16. The method of claim 15, further comprising:
computer usable program code configured to establish an evaluation order for the plurality of security rules; and
computer usable program code configured to process each security rule in order until one of the security rules evaluates as TRUE, in which case lowered ordered security rules are not processed for the request.

17. The computer program product of claim 10, wherein the resource is a RESTful resource.

18. The computer program product of claim 10, wherein an application server is used to execute the computer useable program code configured to receive, to compare, and to determine as defined in claim 10, wherein the security rules utilized by the application server are based upon a plurality of matching rules comprising pattern matching, exact matching, and extension based matching.

19. An application server comprising:
a URI security engine configured to evaluate requests for URI identified resources based upon a plurality of previously established security rules, said URI security engine comprising an exclusion mechanism configured to evaluate security rules comprising exclusion conditional operators; and
a Web server configured to selectively serve a plurality of URI identified resources to requesting clients based upon evaluation results of the URI security engine, wherein the security rules are based upon a plurality of matching rules comprising pattern matching, exact matching, and extension based matching.
